(19) United States
(12) Patent Application Publication
(10) Pub. No.: US 2017/0068572 A1
(43) Pub. Date: Mar. 9, 2017

(54) DIGITAL SAFE ARCHITECTURE USABLE FOR NUMERICAL OBJECTS INTEGRITY PROTECTION IN THE TIME

(71) Applicant: DOCAPOST DPS, CHARENTON LE PONT (FR)

(72) Inventor: Julien LEFEBVRE, PARIS (FR)

(21) Appl. No.: 15/255,759

(22) Filed: Sep. 2, 2016

(30) Foreign Application Priority Data
Sep. 7, 2015 (FR) 15 58286

(51) Int. Cl. G06F 9/50

(52) U.S. Cl. CPC G06F 9/5027; G06F 9/5094; G06F 2209/503

(57) ABSTRACT

The present invention relates to a digital safe architecture (10) usable to preserve the integrity of digital objects over time, the architecture (10) including preservation means making for digital objects and metadata associated with those objects, and computing means (14) able to process a plurality of computing tasks.

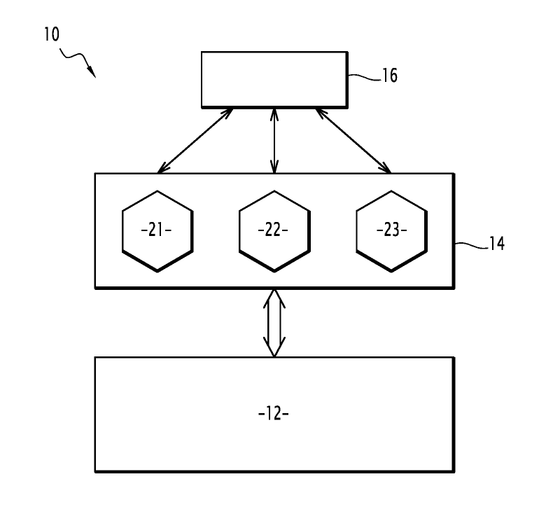

The computing tasks comprise operating tasks relative to the filing, preservation and reconstitution of digital objects, and background tasks relative to the operation of the safe.

The computing means (14) consist of a plurality of separate computing nodes (21, 22, 23) able to execute at least certain computing tasks.

The architecture further includes a task manager (16) making it possible to distribute the computing tasks between different computing nodes (21, 22, 23).

The present invention relates to a digital safe architecture usable to protect the integrity of digital objects over time.

More particularly, the invention relates to such an architecture including preservation means making it possible to preserve digital objects and metadata associated with those objects, and computing means able to process a plurality of computing tasks.

These computing tasks comprise operating tasks relative to the filing, preservation and reconstitution of digital objects, and background tasks relative to the operation of the safe.

Different digital safe architectures exist in the state of the art.

The digital object for example comprises an electronic document, or more generally, any other computer file.

The safes make it possible to preserve the integrity of such digital objects over time and are thus usable in many technical fields. These fields in particular include electronic archiving, electronic document management, digital object security, etc.

In general, each digital safe is made up of a plurality of hardware resources in particular comprising a computer for accessing the safes and preservation means, and a plurality of software resources for allowing the operation of the digital safe using the hardware resources.

The main objective of these resources is to be able to retrieve a digital object as it was placed in the safe, after any preservation duration, and to be able to prove that the digital object has not been modified during that preservation time.

Compliance with these guarantees in particular makes it possible to ensure the probative value of the digital object, which then becomes enforceable, for example in court.

Several reference texts are applicable to digital safes.

These texts in particular include referential FNTC-CFE and standard AFNOR NF Z42-020:2012-07.

To achieve the determined objective, the existing architectures implement close framing of the procedure for filing a digital object in the safe.

In particular, such a filing procedure consists of receiving and verifying each digital object to be filed, creating proof of filing of that object, and placing the object in the preservation means according to predetermined preservation techniques.

This procedure is implemented by the access computer to the safe.

However, with the considerable increase in the number of filings in recent years, the limited performance of the access computer no longer makes it possible to ensure the implementation of this method for all filings.

To offset this problem, it was then proposed to increase the performance of the handling of the filings by successively replacing the access computers with increasingly higher performing computers.

However, this solution lacks flexibility and has the drawback of resulting in considerable costs.

The present invention aims to propose an architecture for a digital safe making it possible to perform a relatively large number of filings, while remaining relatively flexible and inexpensive.

To that end, the invention relates to a digital safe architecture, in which the computing means consist of a plurality of separate computing nodes, each computing node being able to execute at least certain computing tasks independently of the other computing nodes. The architecture further includes a task manager making it possible to distribute the computing tasks between different computing nodes, each computing node being able to perform one or more tasks assigned to it.

According to other advantageous aspects of the invention, the safe architecture comprises one or more of the following features, considered alone or according to all technically possible combinations:
the computing means comprise at least one computing node dedicated to the performance of operating tasks;
the computing means comprise at least one computing node dedicated to the performance of background tasks;
the computing means comprise at least one computing node dedicated to the performance of operating tasks and background tasks;
each operating task is chosen from the group comprising at least the reception of a digital object to be filed, the verification of each received digital object, the generation of metadata relative to each received digital object and forming a proof of filing of that digital object, the sending of a digital object to the preservation means with the corresponding metadata, the consultation of a digital object, the consultation of the metadata relative to a digital object preserved in the preservation means, the retrieval of a digital object, the listing of the digital objects preserved in at least part of the preservation means, and the deletion of a digital object and metadata corresponding to that digital object;
each background task is chosen from the group comprising at least one safe maintenance operation and the processing of asynchronous tasks;
a computing node is produced in the form of an independent computer;
a computing node is produced in the form of an independent software program, such as a virtual machine;
the task manager is able to add or remove each computing node done in the form of a software program;
the task manager is able to distribute the computing tasks between different computing nodes based on the computing power of those nodes;
the task manager is able to verify the availability of each computing node, and when a computing node is unavailable, to generate a corresponding alert.

These features and advantages of the invention will appear upon reading the following description, provided solely as a non-limiting example, and done in reference to the sole FIGURE, showing a diagrammatic view of a digital safe architecture according to the invention.

The FIGURE indeed shows a digital safe architecture designated by general reference 10 in that FIGURE.

The digital safe is usable to preserve the integrity of digital objects over time.

Each digital object for example comprises an electronic document or any other computer file.

Each digital object is associated with metadata comprising digital data relative to that object.

The architecture 10 includes preservation means for the digital objects, computing means making it possible to process a plurality of computing tasks relative to the digital objects, and a manager for those tasks.

These components of the architecture 10 are respectively designated by references 12, 14 and 16 in the FIGURE.

The preservation means 12 for example assume the form of one or more servers able to store the digital objects and metadata associated with those objects securely, using an appropriate storage technique known in itself.

The computing means 14 are able to process a plurality of computing tasks relative to the digital objects and the operation of the safe.

In particular, the computing tasks comprise operating tasks relative to the filing, preservation and reconstitution of digital objects, and background tasks relative to the operation of the safe.

Each operating task is chosen from the group comprising at least:
reception of a digital object to be filed;
verification of each received digital object;
generation of metadata relative to each received digital object and forming proof of filing of that digital object;
sending of a digital object to the preservation means 12 with the corresponding metadata;
consultation of a digital object;
consultation of metadata relative to a digital object preserved in the preservation means;
retrieval of a digital object;
listing of the digital objects preserved in at least part of the preservation means; and
deletion of a digital object and the metadata corresponding to that digital object.

Each background task is chosen from the group comprising at least:
safe maintenance operations; and
asynchronous task processing.

According to the invention, the computing means 14 are made up of a plurality of separate computing nodes.

Each computing node is able to execute at least certain computing tasks independently of the other nodes.

In the FIGURE, three computing nodes are shown.

These computing nodes are designated by general references 21 to 23.

However, it must be understood that the invention is not limited to the illustrated example embodiment.

Thus, the number of nodes is chosen based on the desired processing performance for filings and may be modified dynamically, as will be explained below.

Each computing node 21 to 23 is configured to perform tasks of a same nature or different natures.

Thus, in the example of the FIGURE, the computing node 21 is dedicated to the performance of operating tasks, the computing node 22 is dedicated to the performance of background tasks, and the computing node 23 is dedicated to the performance of operating and background tasks.

Furthermore, each computing node 21 to 23 is made in the form of a computer independent of the other computing nodes or in the form of a software program implemented by a computer shared by several nodes.

In the latter case, the computing node is for example made in the form of a virtual machine.

Thus, such a computing node may be added or deleted dynamically for example based on the computing power necessary at the current moment.

The task manager 16 makes it possible to distribute the computing tasks between different computing nodes 21 to 23.

Each computing node 21 to 23 is then able to perform one or more tasks assigned to it by the task manager 16.

The task manager 16 is for example an independent computer forming a communication interface with the safe and a management center of the safe.

The task manager 16 is thus able to generate a computing task relative to a digital object or to the operation of the safe and to assign that computing tasks to one of the computing nodes 21 to 23.

The assignment of tasks is for example done based on the nature of those tasks and based on the computing power and availability of the corresponding computing nodes 21 to 23.

Thus, for example, since the computing node 21 is dedicated to the performance of operating tasks, the task manager 16 is able to assign only operating tasks to that node.

Similarly, since the computing node 22 is dedicated to the performance of background tasks, the task manager 16 is able to assign only background tasks to that node.

Lastly, since the computing node 23 is dedicated to the performance of tasks of different natures, the task manager 16 is able to assign operating tasks and background tasks.

Furthermore, the task manager 16 is able to verify the availability of each computing node, and when a node is unavailable, to generate a corresponding alert.

According to an alternative embodiment, the task manager 16 is further able to command the addition of a new computing node or the deletion of an existing computing node, for example based on the number of available computing nodes and the number of tasks to be performed.

The operation of the architecture 10 will now be explained.

When it is for example necessary to add a new digital object in the safe, the task manager 16 generates a plurality of operating tasks relative to that object.

In particular, the operating tasks generated by the task manager 16 for example consist of receiving the digital object, verifying the digital object, generating metadata relative to the digital object and sending the digital object to the preservation means 12 with the corresponding metadata.

Then, the task manager 16 assigns all of these operating tasks to one of the nodes 21 or 23 available at the current moment.

When neither of the computing nodes 21 and 23 is available, the task manager 16 generates a corresponding alert and if applicable, dynamically commands the addition of a new computing node.

The task manager 16 can further assign background tasks to the computing nodes 22 or 23, when necessary for example to maintain the operation of the safe.

Of course, other example operating modes and embodiments of the architecture 10 are also possible.

One can then see that the present invention has a certain number of advantages.

In particular, the architecture according to the invention makes it possible to distribute the computing tasks relative to the digital object or the operation of the safe between different computing nodes based on the computing power of those nodes and their availability.

This architecture then leads to a computing performance distribution between the different nodes and avoids the use of a single access computer with limited performance, as proposed in the state of the art.

Thus, when a need to increase the computing performance arises, it suffices to add a computing node.

This then makes the proposed solution more flexible and less costly relative to the existing solutions.

1. A digital safe architecture usable to preserve the integrity of digital objects over time, the architecture including preservation units able to preserve digital objects and metadata associated with those objects, and computing units able to process a plurality of computing tasks;
the computing tasks comprising operating tasks relative to the filing, preservation and reconstitution of digital objects, and background tasks relative to the operation of the safe;
wherein the computing units consist of a plurality of separate computing nodes, each computing node being able to execute at least certain computing tasks independently of the other computing nodes; the architecture further including a task manager able to distribute the computing tasks between different computing nodes, each computing node being able to perform one or more tasks assigned to it.

2. The architecture according to claim 1, wherein the computing units comprise at least one computing node dedicated to the performance of operating tasks.

3. The architecture according to claim 1, wherein the computing units comprise at least one computing node dedicated to the performance of background tasks.

4. The architecture according to claim 1, wherein the computing units comprise at least one computing node dedicated to the performance of operating tasks and background tasks.

5. The architecture according to claim 1, wherein each operating task is chosen from the group comprising:
reception of a digital object to be filed;
verification of each received digital object;
generation of metadata relative to each received digital object and forming proof of filing of that digital object;
sending of a digital object to the preservation units with the corresponding metadata;
consultation of a digital object;
consultation of metadata relative to a digital object preserved in the preservation units;
retrieval of a digital object;
listing of the digital objects preserved in at least part of the preservation units; and
deletion of a digital object and the metadata corresponding to that digital object.

6. The architecture according to claim 1, wherein each background task is chosen from the group comprising:
safe maintenance operations; and
asynchronous task processing.

7. The architecture according to claim 1, wherein at least one computing node is produced in the form of an independent computer.

8. The architecture according to claim 1, wherein at least one computing node (21, 22, 23) is produced in the form of an independent software program.

9. The architecture accordingly to claim 8, wherein said software program is a virtual machine.

10. The architecture according to claim 8, wherein the task manager is able to add or remove each computing node done in the form of a software program.

11. The architecture according to claim 1, wherein the task manager is able to distribute the computing tasks between different computing nodes based on the computing power of those nodes.

12. The architecture according to claim 1, wherein the task manager is able to verify the availability of each computing node, and when a computing node is unavailable, to generate a corresponding alert.
